(19) United States
(12) Patent Application Publication
(10) Pub. No.: US 2008/0030631 A1
(43) Pub. Date: Feb. 7, 2008

(54) Apparatus for a rotatable computer screen guard having screen protector and document holder functionality

(76) Inventor: Michael Gallagher, New York, NY (US)

Correspondence Address: FOX ROTHSCHILD LLP, 100 PARK AVENUE, SUITE 1500, NEW YORK, NY, 10017, US

(21) Appl. No.: 11/890,330

(22) Filed: Aug. 6, 2007

Related U.S. Application Data
(60) Provisional application No. 60/835,979, filed on Aug. 7, 2006.

(51) Int. Cl. H04N 5/65

(52) U.S. Cl. 348/818; 348/834; 348/E05.128

(57) ABSTRACT

A combined computer screen protector and document holder (a screen guard) which can be manufactured as part of or incorporated onto the front of a computer monitor and via a hinge can be easily moved between positions as a screen protector providing anti-glare and privacy functions to that of a tray or support providing document holding and retention functions is presented. The screen protector and document holder comprises two sections, a longitudinal flat section and a flange, which can be integrally connected to one another, which by means of slots cut through the longitudinal section on a side opposite to the flange connect to hinges set onto a computer monitor. The screen protector and document holder can be moved between the two positions by applying physical pressure to move it around the hinge.

### PRIOR PROVISIONAL PATENT APPLICATION

The present application claims the benefit of U.S. Provisional Application No. 60/835,979 filed Aug. 7, 2006, the disclosure of which is hereby incorporated by reference.

### FIELD OF THE INVENTION

The present invention relates to a computer screen protector and document holder, and more particularly, to a screen guard which can be manufactured as part of or incorporated onto the front of a computer monitor and that via a hinge can be easily moved between positions as a screen protector (capable of providing anti-glare and privacy functions) to that as a tray or support providing document holding and retention functions.

### BACKGROUND OF THE INVENTION

Due to the long hours of work spent by individuals today in front of a computer screen, an industry developed to provide those individuals with the physical ergonomics that the human body needed in its computer work station layout. One of the primary goals of ergonomics is prevention of workplace injury. According to the United States Bureau of Labor Statistics, more than 60 percent of the workplace injuries reported each year are associated with repetitive stress or strain injuries. These injuries result from continuous repetition of the same motions, for instance positioning documents and typing. According to the U.S. Department of Labor, Occupational Safety and Health Administration (OSHA), repetitive strain injuries are the nation's most common and costly occupational health problem, affecting hundreds of thousands of American workers, and costing more than $20 billion a year in worker's compensation.

A number of manufacturers approached such work station physical ergonomics by developing pivotal document holders disposed between a computer monitor screen and the keyboard. For example, U.S. Pat. No. 4,893,775 shows a transparent copy holder stand moveable between a first up right position to hold the copy and a second lower position extending over the keyboard to protect the keyboard from dust, spilled drinks, etc. Another example, U.S. Pat. No. 5,651,524 shows a document holder including a transparent easel that is mounted to the sides of a pedestal for a computer monitor so as to be adjustable about 3 mutually perpendicular axes.

In addition to repetitive stress or strain injuries, injuries to the eyes may occur by way of the glare of reflective light from the computer monitor screens. To protect the eyes from incessant glare, ergonomically designed computer monitors are equipped with glare reduction screens.

Other manufacturers created monitor filters for glare pivotally mounted to computer screens. For example, U.S. Pat. No. 5,668,612 shows a pivotable protective screen for a computer monitor that can be mounted at the top of the screen and pivoted to the top of the screen. Another example, U.S. Pat. No. 4,863,242 shows a pivotally mounted visor for a computer screen that can have a copy holder mounted to the side on a mounting bracket.

Thus the state of the industry at the current time shows movable transparent document holders that may be placed in front of a computer monitor and additionally separate anti-glare screens that may be disposed upon the monitors, however, it has not been shown in the industry that a specific arrangement of a device that can be incorporated into a computer monitor with the combined function of a computer screen protector and a document support with a transparent panel that is hinged so that it can be swung to cover the screen or to support documents in a fixed position.

Thus, as can be seen, while attempts have been made to provide for document holders and, separately, screen protectors to deal with particular individual health issues, there is a need for a device with a combined function of a computer screen protector and document holder.

### SUMMARY OF THE INVENTION

The invention relates to a computer screen protector and document holder (together referred to as a “screen guard”) that includes a rectangular transparent screen, made of anti-glare glass or plastic, with a hinge that can be manufactured integrally with or fastened to a low portion of the computer monitor so that the screen guard can move between (1) a first position in front of the computer monitor screen to act as a screen protector and to provide an anti-glare function from the front and privacy from the side, and (2) a second position extending at an angle downwardly from the monitor to form a tray or support to hold a document.

In another embodiment, the screen guard has a flange that fits over the top of the monitor when the screen guard is in the first position which may be fastened to the top of the monitor via a rubber friction pad or some other fastener. In another embodiment, no flange is present so that the screen guard may be used with different computer monitors.

In yet another embodiment, the hinge may be manufactured integrally with or fastened at a top portion of the computer monitor, for instance a laptop computer, so that the screen guard can move between (1) a position extending upwardly from the monitor to for a tray or support to hold a document, and (2) a position in front of the computer monitor screen to act as a screen protector and to provide an anti-glare function from the front and privacy from the side.

In yet another embodiment, a separate cradle is used on which the screen guard can rest when in the second position. The cradle may have a slot for holding a document when the screen guard is in the first position.

The screen protector and document holder may be formed as a new installation to a presently manufactured monitor or incorporated into the front of the computer monitor itself. In either case, the versatility of the device allows the user to view documents easily when entering data and allows quick control for privacy or bright light.

The present invention, including its features and advantages, will become more apparent from the following detailed description with reference to the accompanying drawings.

### BRIEF DESCRIPTION OF THE DRAWINGS

FIG. 1A is an illustration of a front view of the computer screen protector and document holder in a first position in front of the computer screen, according to an embodiment of the present invention.

FIG. 1B is an illustration a front view of the present invention in a second position extending at an angle downwardly from the monitor.

FIG. 2A is an illustration of a side view of the present invention in a first position, moved from a second position as indicated by the dotted lines and arrow, according to an embodiment of the present invention.

FIG. 2B is an illustration of a side view of the present invention in a second position, moved from a first position as indicated by the dotted lines and arrows, according to an embodiment of the present invention.

FIG. 3 is an illustration of an isometric view showing the present invention with hinges that can be fastened to a low portion of the computer monitor, according to an embodiment of the present invention.

FIGS. 4A, 4B, and 4C are illustrations of an isometric view, a front view and a side view, respectively of the hinge system, according to an embodiment of the present invention.

FIG. 5A is an illustration of a side view of a computer screen protector and document holder in a first position extending from a top portion of the monitor of a lap top computer, according to another embodiment of the present invention.

FIG. 5B is an illustration of a side view of the present invention in a second position in front of the computer screen of the lap top computer, according to another embodiment of the present invention.

FIG. 6 is an illustration of a isometric side view of the present invention in a first position, according to another embodiment of the present invention.

### DETAILED DESCRIPTION

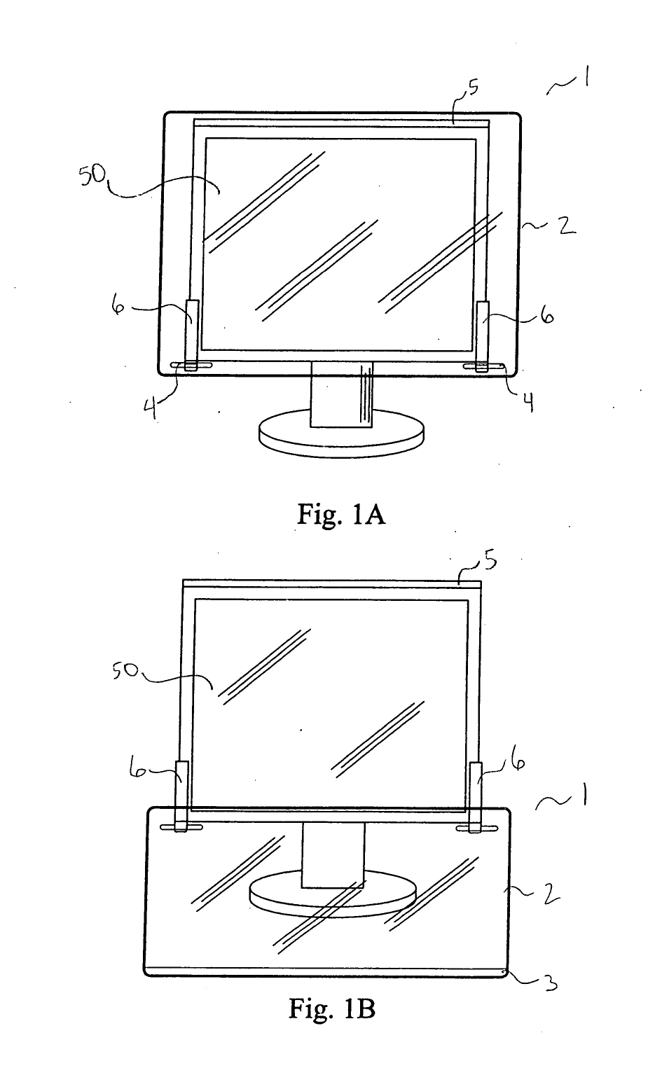

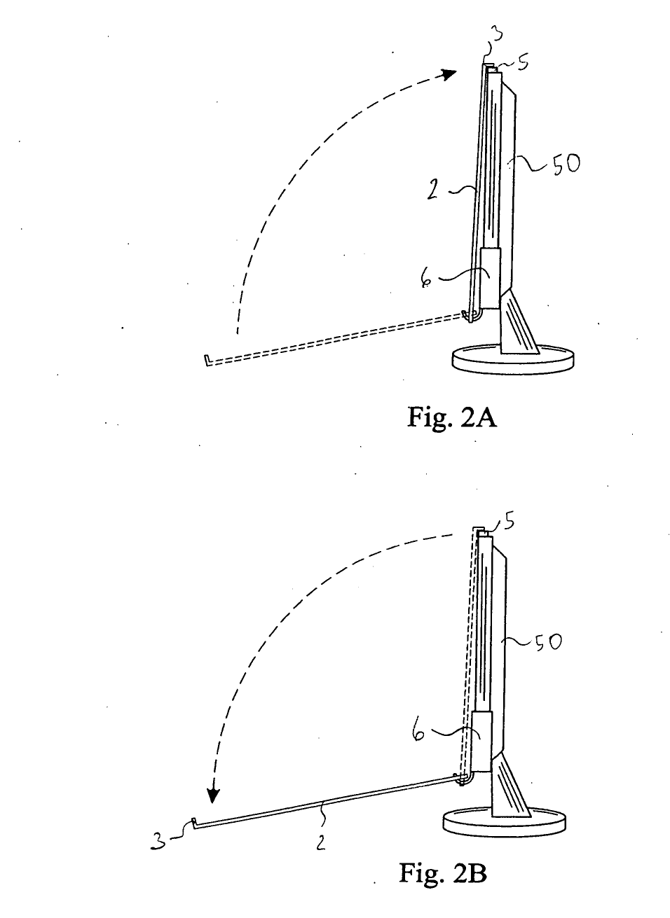

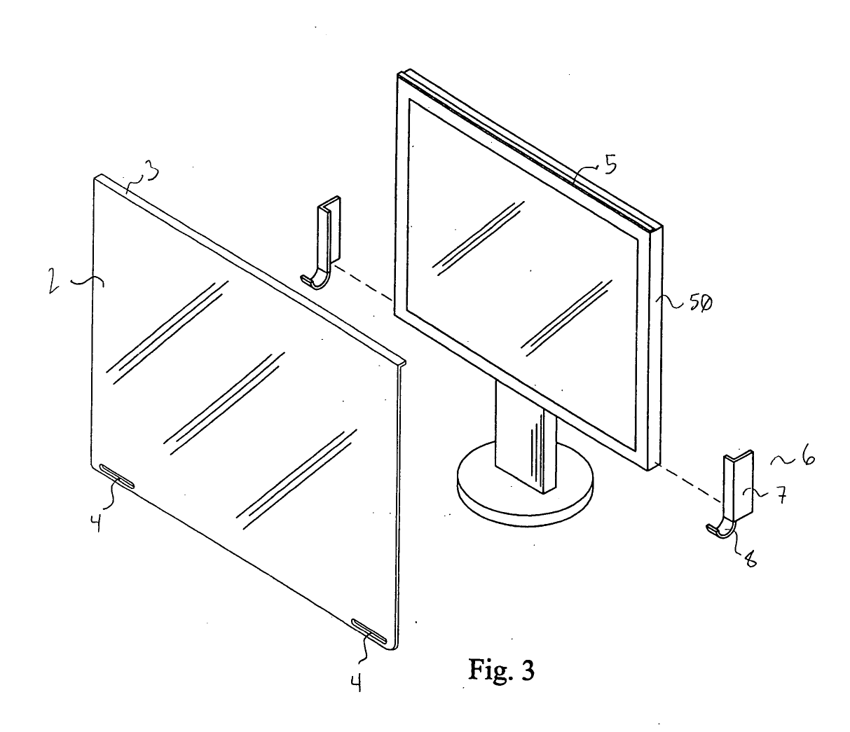

FIGS. 1 through 6 illustrate an apparatus for a combined computer screen protector and document holder (together referred to as a “screen guard”) which can be manufactured or incorporated onto the front of a computer monitor and via a hinge can be easily moved between positions as a screen protector, providing anti-glare and privacy functions, to that of a tray or support to function to hold a document. The screen protector and document holder can be constructed of an anti-glare glass or plastic (for example, a high density polyethylene). Of course it is to be understood that other materials may be used in so far as they provide easy viewing of a computer monitor and provide an anti-glare function from the front and a privacy function from the side. Joining of the glass or plastic pieces of the screen protector and document holder may be by any suitable process to achieve a desired joining and proper form.

Referring now to FIGS. 1A, 1B, 2A, 2B and 3, a combination computer screen protector and document holder 1 (hereinafter also referred to as a screen guard 1) are shown in various positions in front of a computer monitor 50. The screen protector and document holder 1 comprises two sections which are integrally connected one to the other. These two sections are a longitudinal flat section 2 and a flange 3.

The longitudinal flat section 2 is constructed preferably in generally a rectangular shape, although it is to be understood that such shape may be sized according to the shape and size of the computer monitor 50 on which it is to fit. Further considerations when sizing the rectangular shape are the work space the screen guard is to fit into, the papers sizes to be retained and/or held, and the monitor size.

The flange 3 is connected on a side edge of the longitudinal section 2. For purposes of constructing and/or forming the flange 3, heat may be applied to the side edge of the longitudinal section 2 such that it may be bent and shaped into the flange 3. This provides the option of molding the flange 3 to the type and/or variety of computer monitor over which the screen guard will be fitted. It is to be understood, however, that the flange 3 may be snap connected, rather than integral, to the longitudinal flat section 2. Such snap connection will allow for snap-on and snap-off connection of the flange 3 as the user of the screen guard 1 desires.

Further, in a preferred embodiment, the screen guard 1 will have rounded corners to prevent injury to the computer user by accidental scraping or cutting of the user when working in and around the computer monitor such as when utilizing of the computer mouse. However, it is to be understood, that such rounding of the corners of the screen guard 1 is for ergonomic reasons and that accordingly the corners may be shaped differently depending on various factors.

Cut through the longitudinal section 2, towards the side opposite of where the flange 3 is located, is at least one slot 4. Preferably, as shown in the Figures, two slots may be positioned near to each corner of the longitudinal section 2. Also preferably, the slots 4 are cut completely through the material of the longitudinal section 2 and are cut in a length-wise direction horizontally. It is to be understood, however, that there may be as many or as few slots 4 as required, and that the slots 4 may be cut in differing shapes such as circular, square or rectangular.

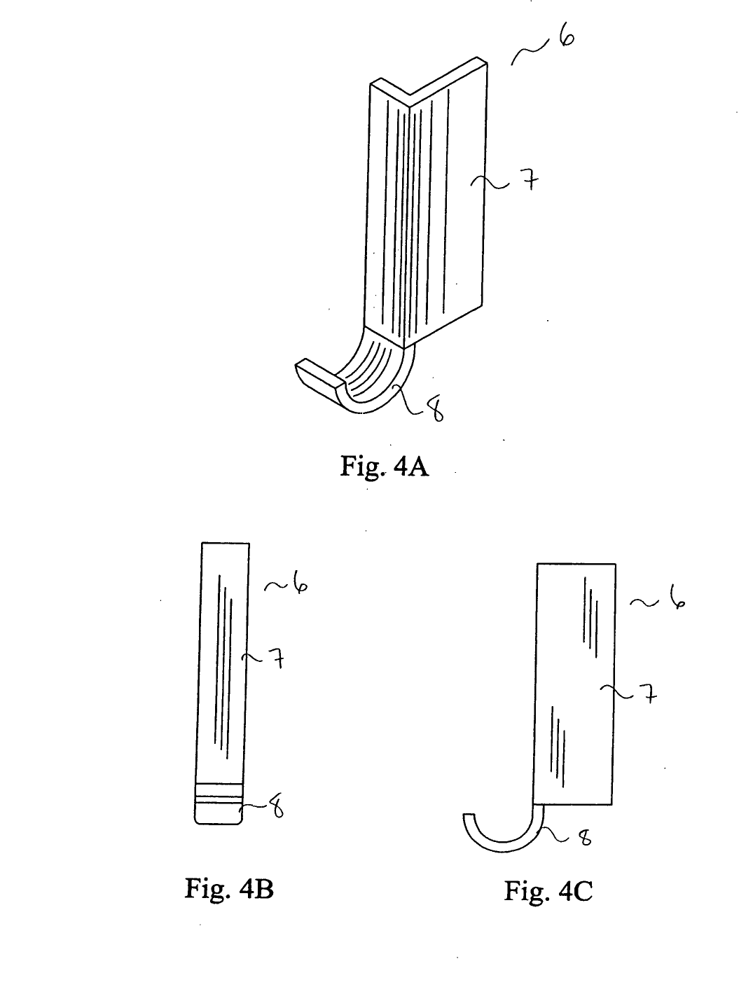

In addition, the computer monitor 50 also has connected to it a hinge 6. Hinge 6 may be constructed such that it is integrally connected to computer monitor 50, or such that it snaps on/off to the monitor 50, or is attached to the monitor 50 by means of an adhesive. Preferably, the hinge comprises a hinge connector 7 and a hinge cradle 8. Referring now specifically to FIGS. 4A, 4B and 4C, the hinge connector 7 is preferably shaped in a “L” shape which can be molded to fit the front and side edges of the computer monitor 50. By such construction, it is clear that the hinge connector 7 may be integrally manufactured as part of the front/side edge of the computer monitor 50, may have an adhesive (not shown) placed on an inner side portion of the hinge connector 7 such that the adhesive is placed towards the computer monitor, or that it may allow for a snap on/off construction, the last two constructions thereby allowing for the hinges to be later added onto the computer monitor.

Referring further to FIGS. 4A, 4B and 4C, the hinge 6 has integrally connected to the hinge connector 7 a hinge cradle 8. The hinge cradle 8 is preferably constructed to take the shape of a half circle. Such half circle design allows the slot 4 of the screen guard 1 to easily be positioned into the cup portion of the hinge cradle 8. It is to be understood, of course, that the hinge cradle 8 need not be limited in its manufacture to that of a half circle shape, but rather may be manufactured to be completely closed, thereby forming a complete circle, or to be any shape between that of a complete circle shape and a half circle shape in so far as the slot 4 of the screen guard 1 can be securely cupped by the hinge cradle 8. In a preferred embodiment, the screen guard 1 may be snapped onto and off of the monitor 50 by interaction of the hinge cradle 8 and the slot 4. Thus it is to be understood that the screen guard 1 is removable and/or liftable in this fashion.

Completing construction of the screen guard 1, a friction pad 5 may be manufactured or incorporated onto the front top portion of the monitor 50 above the monitor's screen. The function of the friction pad 5 is to increase stability of the screen guard 1, while in the screen protector position. Alternatively, such friction pad may be incorporated integrally into the screen guard 1 either on the flange 3, or due to construction of the monitor 50, on the longitudinal section 2. The friction pad may also act as a catch by which the screen guard 1 may be fixed (opposite the positioning of the hinge 6) to the monitor 50. Such fixing means may be accomplished by a snap on/off apparatus or a hook and loop fastener (e.g., Velcro).

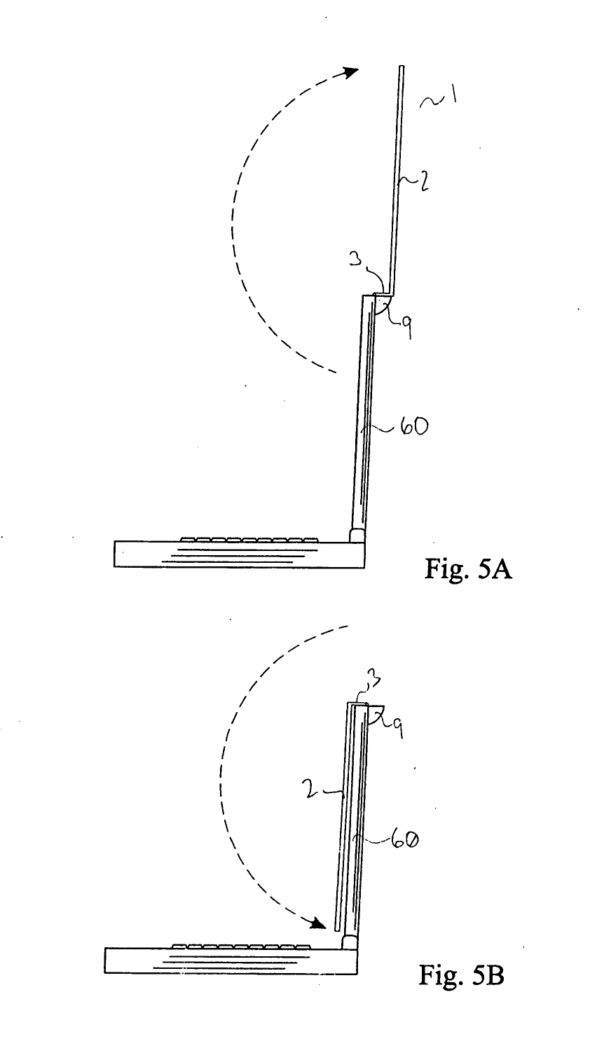

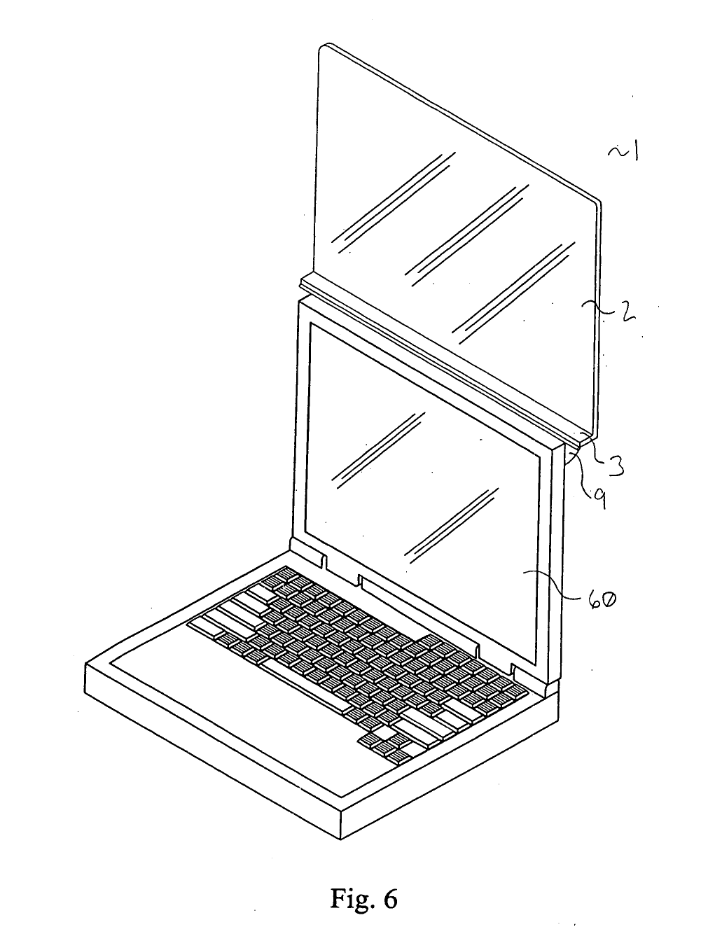

It is to be understood of course that alternative embodiments of the computer monitor 50 may be that of as a component of a desktop computer, be constructed as a wall mounted monitor (not shown), or be constructed as the monitor of a lap top computer. Accordingly, referring now specifically to FIGS. 5A, 5B and 6, an alternative embodiment in which the computer monitor 50 is a component of a lap top computer is shown. The screen guard 1, in this embodiment, rather than being hinged at a lower portion of the monitor is hinged at an upper and/or top portion of the lap top computer monitor 60. The hinge 9 may be such that it is integrally connected to the computer monitor 60, or may be such that it is manufactured or incorporated to fit onto the top and or front portion of the computer monitor 60.

As can be seen from the above described embodiments, the combined computer screen protector and document holder 1 has two primary positions, each having a different function. The first position of the screen guard 1 is that whereby it sits in front of the monitor 50/60 to provide anti-glare and privacy functions (i.e., the anti-glare/privacy position). The second position of the screen guard 1 is that where it sits above or below the monitor 50/60 (depending on the utilized embodiment) to provide document holding and/or retention functions (i.e., the document holding position). Movement between the two primary positions, as shown by the dotted movement arrows in the various figures, is accomplished by providing pressure on the screen guard 1 to rotate it about the hinge point created by the hinge(s) 6/9 (depending on the utilized embodiment). Movement around the hinge point may be freely rotating or may be such that the screen guard 1 is biased towards one position or the other. It is to be further understood of course that various forms of hinges may be utilized.

In yet another embodiment, a separate cradle (not shown) may be utilized to sit in front of the desk top computer or lap top computer onto which the screen guard 1 can rest when in a document holding position. In such a manner, the separate cradle acts to support the screen guard 1 when in the document holding position. When the screen guard 1 is in an anti-glare/privacy position the separate cradle can act to hold a document.

Therefore, based on the above described construction and operation it is to be understood that the screen protector and document holder 1 may be manufactured either as an integral part of the computer monitors 50 and/or 60 by a manufacturer of such computer components, or may be such that it is manufactured and marketed as a separate piece that may be later attached (as described by one of the methods mentioned above) to the monitors after their manufacture.

Thus as can be seen, the construction and implementation of the present invention both allow for users of the present invention to easily adjust the screen guard to a position suited for the needed function, and for manufacturers of the present invention an adjustable manufacturing and distribution process.

In the foregoing description, the method and apparatus of the present invention have been described with reference to a specific example. It is to be understood and expected that variations in the principles of the method and apparatus herein disclosed may be made by one skilled in the art and it is intended that such modifications, changes, and substitutions are to be included within the scope of the present invention as set forth in the appended claims. The specification and the drawings are accordingly to be regarded in an illustrative rather than in a restrictive sense.

What is claimed is:

1. An apparatus for a screen protector and document holder, the apparatus comprising:
a longitudinal flat section;
a flange connected on a side edge of the longitudinal flat section; and
at least one slot cut through the longitudinal flat section,
wherein the at least one slot may be positioned into a hinge allowing for movement of the apparatus between a first position to provide at least one of an anti-glare function and a privacy function and a second position to provide a document holder function.

2. The apparatus of claim 1, wherein the longitudinal flat section is sized to cover a substantial portion of a screen.

3. The apparatus of claim 1, wherein the flange is adapted to fit over a monitor.

4. The apparatus of claim 1, wherein the hinge is adapted to be removably attached to a monitor.

5. The apparatus of claim 1, wherein the hinge is adapted to be permanently attached to a monitor.

6. The apparatus of claim 1, further comprising:
a friction pad, to increase stability when the apparatus is in a first position.

7. The apparatus of claim 6, wherein the friction pad is affixed to at least one of the longitudinal flat section and the flange.

8. The apparatus of claim 1, wherein the hinge comprises:
a hinge connector, adapted at one end to be attached to a monitor; and
a hinge cradle attached to the hinge connector at the other end.

9. The apparatus of claim 1, wherein movement of the apparatus between the first position and the second position is at least one of freely rotating and biased towards one position.

10. A system for providing screen protection functionality and document holding functionality, the system comprising:
a monitor having a screen;
a hinge having a first section and a second section wherein the first section is attached to the monitor; and
a screen guard comprising:
a flat section having a first side and a second side, and
a flange disposed on the second side of the screen guard,
wherein the first side of the screen guard is attached to the second section of the hinge, and
wherein the screen guard is rotatable around a hinge point of the hinge between the screen protection functionality and the document holding functionality.

11. The system of claim 10, wherein the monitor is a monitor of a desktop computer.

12. The system of claim 11, wherein the hinge is attached at a lower portion of the monitor.

13. The system of claim 10, wherein the monitor is a monitor of a laptop computer.

14. The system of claim 12, wherein the hinge is attached at a higher portion of the monitor.

15. The system of claim 10, wherein the flat section is sized to cover a substantial portion of the screen.

16. The system of claim 10, wherein the flat section is constructed of an anti-glare material.

17. The system of claim 10, wherein the screen guard is substantially parallel to the screen when providing screen protection functionality.

18. The system of claim 10, wherein the screen guard is substantially perpendicular to the screen when providing document holding functionality.

19. The system of claim 10, wherein when the screen guard is providing screen protection functionality it is also capable of providing at least one of anti-glare functionality and privacy functionality.

20. The system of claim 10, wherein when the screen guard is providing document holding functionality it is also capable of providing document retention functionality.
